(19) United States
(12) Patent Application Publication
(10) Pub. No.: US 2013/0103834 A1
(43) Pub. Date: Apr. 25, 2013

(54) Multi-Tenant NATting for Segregating Traffic Through a Cloud Service

(71) Applicants: Janis Dzerve, Sunnyvale, CA (US); Meenakshi Sundaram Lakshmanan, Hayward, CA (US)

(72) Inventors: Janis Dzerve, Sunnyvale, CA (US); Meenakshi Sundaram Lakshmanan, Hayward, CA (US)

(73) Assignee: Blue Coat Systems, Inc., Sunnyvale, CA (US)

(21) Appl. No.: 13/279,146

(22) Filed: Oct. 21, 2011

(51) Int. Cl. G06F 15/173; G06F 15/16

(52) U.S. Cl. 709/225; 709/245

(57) ABSTRACT

An apparatus, system, and method for segregating customer traffic through a cloud service are disclosed. The apparatus, system, and method perform network address translation (NAT) on first data packets received from a subnet to translate a first private network IP address into a second private network IP addresses, perform network address and port translation (NAPT) on the first data packets to translate the second private network IP address into a second public network IP address before sending the first data packets to a remote host, perform NAPT on second data packets received from the remote host to translate the second private network IP address back into the first private network IP address, and perform NAT on the second data packets to translate the second private network IP address back into the first private network IP address before sending the second data packets to the subnet.

### BACKGROUND

A. Technical Field

The present disclosure generally relates to multi-tenant NATting for segregating traffic through a cloud service. In particular embodiments, the present invention relates to an apparatus, system, and method for applying NAT and NAPT to data packets to allow traffic for a plurality of customers to be more efficiently and accurately tracked by a cloud service that utilizes software with a multi-tenant architecture.

B. Background Technology

The term “cloud computing” refers to the movement of applications, services, and data from personal computing devices (e.g., desktop and laptop computers, tablet computers, netbooks, personal digital assistants (PDAs), smart phones, etc.) to third-party computing resources (e.g., network grids, server farms, etc.) via a digital network (e.g., a wide area network (WAN), the World Wide Web, etc.). Accordingly, such third-party computing resources are typically located off premises and implemented as a service, often referred to as software as a service (SaaS). Various organizations leverage such services to extend their information technology (IT) capabilities while reducing the cost of ownership because cloud computing allows those organizations to centralize software and data storage management while eliminating the need for the in-house hardware, software, and IT personnel that would otherwise be required to build, support, and maintain enterprise computing solutions. The use of cloud services can even reduce an organization's energy costs.

The organizations that utilize cloud services often comprise subnetworks, or subnets, within the digital network of which they form a part. Within those subnets, computing devices can communicate with each other without being connected to the digital network. Accordingly, those computing devices do not need addresses that are unique within the digital network. They only need addresses that are unique within their respective subnets.

Within subnets, computing devices are assigned private network addresses typically selected from one of three classes—Class A (10.0.0.0 through 10.255.255.255), Class B (172.16.0.0 through 172.31.255.255), and Class C (192.168.0.0 through 192.168.255.255)—as described, for example, in the Internet Engineering Task Force's (IETF's) Request for Comment (RFC) 1918. But because different subnets can assign private network addresses from the same classes, one or more subnets may utilize one or more of the same private network addresses as one or more other subnets. Accordingly, those private network addresses are typically hidden behind one or more unique public network addresses when data is transmitted via the digital network from a computing device within a subnet to a computing device in another subnet and/or a remote host, or original content server, outside of the subnet. Although such unique public addresses distinguish between data transmitted from computing devices with potentially identical private network addresses, they result in ambiguity when data is transmitted back to those computing devices because those public network addresses only identify the subnet from which the forward data originated, not the respective computing device within the subnet that originated the forward data to which the return data is a response.

To resolve such ambiguities, servers within those subnets typically include translation agents that perform network address and port translation (NAPT) on data packets as they are transmitted out of a subnet. As described, for example, in RFC 2663, the NAPT process, or NAPTing, includes not only modifying the private network address of the computing device from which the forward data packets were originated, it also includes altering higher level information, such as Transmission Protocol (TCP) and User Datagram Protocol (UDP) ports, so that return data packets can be routed back to the specific computing device that originated the forward data packets. To keep track of that identifying data, the results of the translation are saved in a mapping table, or state table, so it can be used to match to the return data packets to the appropriate computing device to which they should be returned.

Although NAPTing eliminates overlapping network addresses and resolves ambiguities in point-to-point transmissions to and from subnets within a digital network, it poses significant problems for certain applications that perform in-line analysis of the data as it is transmitted between those points. For example, some organizations rely on cloud services, such as Blue Coat Systems, Inc. web security cloud services, to provide real-time protection against web-borne threats. That cloud service provides extensive web application controls and detailed reporting features that allow IT administrators to create and enforce granular policies for individual users, or groups of users, within a customer organization.

To enable IT administrators to create and enforce granular policies via a web security cloud service, the web security cloud service must be able to identify individual users, or groups of users, that are accessing their internet destinations through that cloud service. To obtain those specific private network addresses, a virtual private network (VPN) connection is typically established between the cloud service and individual computing devices in the subnet using a tunneling protocol (e.g., Point-to-Point Tunneling Protocol (PPTP), Layer 2 Tunneling Protocol (L2TP), Internet Protocol Security (IPsec), etc.). As a result, the cloud services can receive data packets without the need for the subnet server to perform NAPT on the private network addresses of the computing devices that originated those data packets. In other words, the cloud service becomes a “virtual” part of the subnet with which it has a VPN connection.

Although establishing a VPN connection with a subnet allows cloud services to receive data packets with private network addresses that have not been NAPTed, eliminating the NAPT process gives rise to the potential for overlapping network addresses to occur within the cloud service when the associated services are provided using a multi-tenant software architecture. A multi-tenant software architecture allows a cloud service provider serve multiple customer organizations, or tenants, with a single instance of its cloud service software. However, such a cloud service will not be able to distinguish between data packets with overlapping private network addresses within the tunneled traffic flowing through its different VPN connections with different subnets.

In the example of a web security cloud service, the inability to distinguish between overlapping private network addresses prevents that cloud service from identifying the specific computing devices that originated data packets and, therefore, prevents that cloud service from being able to perform in-line analysis of those data packets in accordance with a policy that is specific to an individual user, or groups of users, within a customer organization. That problem is exacerbated by the fact that those private network addresses only identify a computing device within a subnet. Thus, where a computing device can be utilized by different users, even the ability to distinguish between overlapping private network addresses may not be enough to identify the user- or group-specific policy that should be applied to the data packets being transmitted to and from that computing device.

### SUMMARY

In particular embodiments, the present invention is directed to an apparatus, system, and method for segregating customer traffic through a cloud service. The apparatus, system, and method perform network address translation (NAT) on first and second data packets as they are transmitted between the cloud service and a plurality of subnets, the NAT being performed to translate each of a plurality of first private network IP addresses from the plurality of subnets into a second private network IP address for use within the cloud service after said first data packets are received from the plurality of subnets and to translate the second private network IP address back into a corresponding one of the plurality of first private network IP addresses before said second data packets are sent to the plurality of subnets. The apparatus, system, and method also perform network address and port translation (NAPT) on the first and second data packets as they are transmitted between the cloud service and one or more remote hosts, the NAPT being performed to translate a first public network IP address for the one more remote hosts into the second private network IP address after said second data packets are received from the one or more remote hosts and to translate the second private network IP address into a second public network IP address for the cloud service before sending said first data packets to the one or more remote hosts. Those and other objects of the present invention, as well as many of the intended advantages thereof, will become more readily apparent with reference to the following detailed description of the preferred embodiments, taken in conjunction with the accompanying drawings.

### BRIEF DESCRIPTION OF THE DRAWINGS

Illustrative aspects of the present invention are described in detail with reference to the following figures, which form part of the disclosure, wherein:

FIG. 1 is a schematic view illustrating an example data path architecture of a digital network with in-line cloud services according to non-limiting embodiment of the present invention;

FIG. 2 is a schematic view illustrating an example data path architecture of in-line cloud services according to non-limiting embodiment of the present invention;

FIG. 3 is a schematic view illustrating an example data path architecture of a datapod according to non-limiting embodiment of the present invention;

FIGS. 4A and 4B are tables illustrating examples of the types and locations of address translation that are performed on forward and return data packets, respectively, according to a non-limiting embodiment of the present invention;

FIG. 5 is a table illustrating an example NAT mapping table according to a non-limiting embodiment of the present invention;

FIG. 6 is a table illustrating an example NAPT mapping table according to a non-limiting embodiment of the present invention; and

FIGS. 7A and 7B are flow charts illustrating an example process for transmitting and receiving data packets through in-line cloud services according to non-limiting embodiment of the present invention.

In those figures, like reference numerals refer to like parts, components, structures, and/or processes.

### DETAILED DESCRIPTION OF THE PREFERRED EMBODIMENTS

The present invention provides an apparatus, system, and method for segregating traffic through a cloud service that utilizes a multi-tenant software architecture. The apparatus, system, and method can segregate traffic through a cloud service based on specific users and/or groups of users. Because such an apparatus, system, and method allow policies to be applied on a granular basis to specific users and/or groups of users, the present invention is particularly suited for use with web security cloud services.

Several preferred embodiments of the present invention are described below for illustrative purposes, it being understood that the invention may be embodied in other forms not specifically illustrated in the drawings. And in describing the preferred embodiments illustrated in the drawings, specific terminology is resorted to for the sake of clarity. However, the present invention is not intended to be limited to the specific terms so selected, and it is to be understood that each specific term includes all technical equivalents that operate in similar manner to accomplish a similar purpose. For example, although the preferred embodiments are described primarily with respect to web security cloud services provided via a multi-tenant software architecture, the present invention also may be implemented to provide similar advantages in other types of cloud services provided via a multi-tenant software architecture.

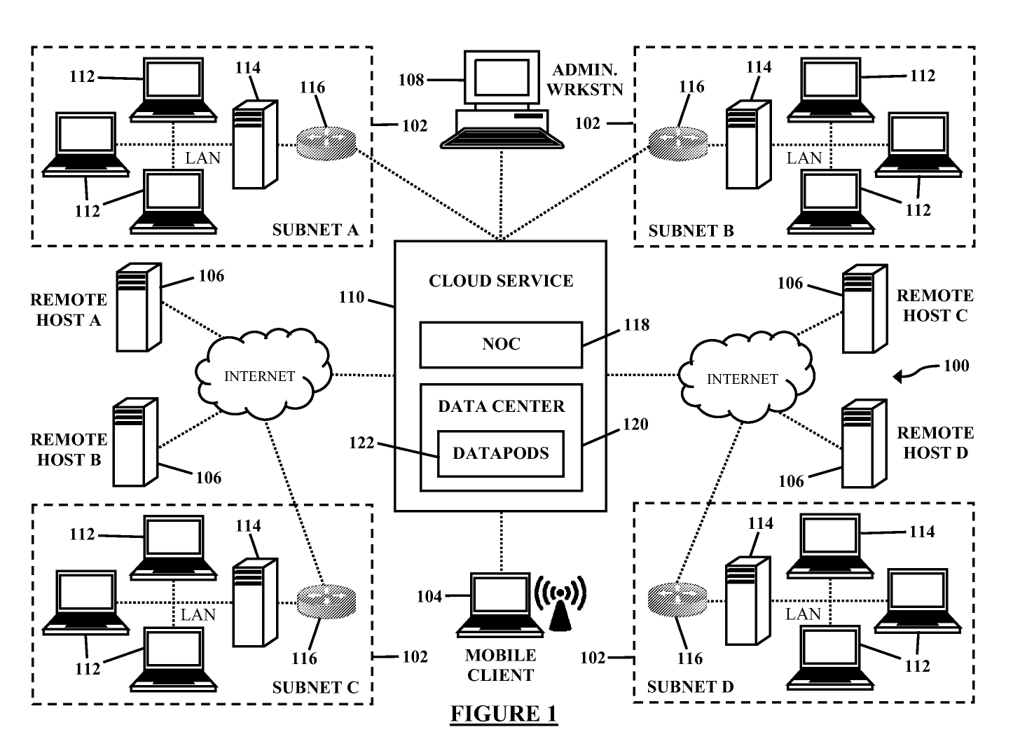

Turning to the drawings, FIG. 1 is a schematic view illustrating the data path architecture of a digital network 100. The digital network 100 is a public network, such as the World Wide Web, and includes the Internet, a plurality of subnets 102, one or more mobile devices 104, a plurality of remote hosts 106, one or more administrative workstations 108, and a cloud service 110. The subnets 102 and mobile devices 104 are managed by customers that arrange with the party that maintains the cloud service 110 (i.e., the service provider) to obtain the service(s) provided within the cloud service 110, such as via a subscription, registration, and/or service contract. Those arrangements include choosing policies for users of the subnets 102 and mobile devices 104 that define the specific service(s) that will be provided to those users, or groups of users. And as those users, or groups of users, generate data queries at the subnets 102 and mobile devices 104, the cloud service 110 performs in-line analysis of the corresponding data packets in accordance with the policies chosen for those users, or groups of users, as those data packets are transmitted from the subnets 102 and mobile devices 104 to the remote hosts 106. Depending on the policy and the type of connection the subnets 102 and mobile devices 104 have with the service provider, the cloud service 110 may also perform that analysis on the data packets that are returned the subnets 102 and mobile devices 104 from the remote hosts 106 in response to those queries.

In FIG. 1, two of the subnets 102 are in electronic data communication with the cloud service 110 via a firewalled VPN configuration (i.e., “Subnet A” and “Subnet B”); one of the subnets 102 is in electronic data communication with the cloud service 110 using an explicit proxy configuration (i.e., “Subnet C”); one of the subnets 102 is in electronic data communication with the cloud service 110 using a proxy forwarding configuration (i.e., “Subnet D”); the mobile device 104 is in electronic data communication with the cloud service using a mobile VPN configuration; and the plurality of remote hosts 106 are in electronic data communication with the cloud service 110 using any suitable configuration. That electronic data communication is preferably performed using a common network addressing architecture, such as Internet Protocol version 4 (IPv4) and/or Internet Protocol version 6 (IPv6). And the firewalled VPN configuration preferably utilizes the IPsec protocol to secure the communications between the cloud service 110 and the corresponding subnets 102; the explicit proxy configuration and the proxy forwarding configuration preferably utilizes the Hypertext Transfer Protocol (HTTP) protocol to secure the communications between the cloud service 110 and the corresponding subnets 102; and the mobile VPN configuration preferably utilizes the Secure Socket Layer (SSL) to secure the communications between the cloud service 110 and the mobile device 104. Although those specific connection configurations and protocols are described as being used in the exemplary embodiment of FIG. 1, other connection configurations and protocols (e.g., a WAN connection utilizing the Point-to-Point protocol).

### A. Subnets 102

Each subnet 102 includes a plurality of GUIs 112 and one or more subnet servers 114 that are in electronic data communication with each other via a secured, private connection, such as a local area network (LAN) or Virtual LAN (VLAN) connection. As illustrated in FIG. 1, each subnet 102 also includes a router 116, but they may also consist internally of multiple physical Ethernet segments interconnected by network switches or network bridges. The GUIs 112 and the subnet server 114 are in electronic data communication with the cloud service 110 via the router 116.

The GUIs 112 of each subnet 102 may be any suitable computing devices (e.g., desktop and laptop computers, tablet computers, netbooks, PDAs, smart phones, etc.) that have graphical displays (e.g., screens, monitors, etc.) configured to display data to users in a meaningful manner and user interfaces (e.g., keyboards, mouse, touch screens, etc.) configured to receive input from the users. The subnet server 114 of each subnet 102 may be any suitable computer, or series of computers, (e.g., an active directory server, a database server, an enterprise server, etc.) that is configured to link the GUIs 112 together and to provide essential services across each of their respective subnets 102. And the router 116 of each subnet 102 may be any suitable gateway computer (e.g., an edge router, an enterprise router, etc.) that is configured to forward data packets between the GUIs 112 in that subnet 102, between that subnet 102 and other subnets 102, and between that subnet 102 and the cloud service 110 via incoming and outgoing interface connections. Each router 116, GUI 112, and subnet sever 114 within each subnet 102 includes one or more central processing units (CPUs) that are configured to execute the instructions of a computer program, or software, and carry out the functions of those devices, as also discussed in more detail below.

The router 116 within each subnet 102 provides a logical and/or physical border between that subnet 102 and other subnets 102, as well as the cloud service 110. Accordingly, each of the GUIs 112 and each subnet server 114 within each subnet 102 are addressed with private network internet protocol (IP) addresses and the router 116 within each subnet 102 is addressed with a public IP address. Each of the private network addresses assigned to the GUIs 112 and subnet server 114 utilize a common, identical, most-significant bit-group, thereby providing a logical division of those IP addresses into two fields: (1) a network or routing prefix that identifies the specific subnet 102 and (2) a rest field that identifies the specific GUI 112 or subnet server 114 within that subnet 102. The routing prefix is expressed in Classless Inter-Domain Routing (CIDR) notation with the first address of the subnet 102 followed by the bit-length of the prefix, separated by a slash (/) character. For example, 192.168.0.1/24 is the IPv4 32-bit routing prefix of a specific GUI 112 or subnet server within a specific subnet 102, wherein the prefix utilizes the first 24 bits (i.e., 192.168.0._) to identify that subnet 102 while utilizing the remaining 8 bits (i.e., _._._{—}.1) to uniquely identify the specific GUI 112 or subnet server 114 within that subnet 102. The public network address assigned to the router 116 is formatted similarly, except that all 32 bits (e.g., 209.179.21.76) of the 32-bit routing prefix are utilized to uniquely identify the subnet 102 within the digital network 100.

1. VPN Configuration

In the subnets 102 that utilize a firewalled VPN configuration (i.e., “Subnet A” and “Subnet B”), the subnet server 114 in those subnets 102 is further configured to perform VPN processing on the data packets transmitted to the cloud service 110 from the GUIs 112 of the corresponding subnet 102. That VPN processing includes encrypting and/or authenticating the data packets and encapsulating them into a new data packet with a new header. The new data packets include both the private network address of the GUI 112 or subnet server 114 that originated them and the public network address of the router 116 of the subnet 102 in which they were originated. Accordingly, data packets from the subnets 102 that utilize a firewalled VPN configuration arrive at the cloud service 110 with information sufficient to identify both the subnet 102 from which the data packet originated and the specific GUI 112 or subnet server 114 that originated that data packet within that subnet 102.

Also in the subnets 102 that utilize a firewalled VPN configuration (i.e., “Subnet A” and “Subnet B”), the subnet server 114 is configured to identify the specific users logged on to each GUI 112 via an authentication agent. The authentication agent will then send that user information to the cloud service 110, together with the public network addresses of the routers within any subnets 102 maintained by the customer associated with that user, the private network address of the GUI 112 to which that user is logged on, and any information required to identify the policy chosen by that customer to be applied to the data traffic generated by that user. Accordingly, when the cloud service 110 receives data packets via the firewalled VPN connection, it can decrypt those data packets and uniquely identify the specific user that originated those data packets by matching the private network address provided with each data packet to the private network address associated with that specific user. Identifying specific users in that manner allows the cloud service 110 to apply different policies to different users on a granular, user-by-user basis.

2. Explicit Proxy Configuration

In the subnet 102 that utilizes an explicit proxy configuration (i.e., “Subnet C”), each of the GUIs 112 in that subnet 102 includes a client-side application that is explicitly configured to communicate with the cloud service 110 and to access to content through the cloud service 110 (e.g., a web browser, an Instant messaging client, a streaming client, etc.), which means that the client-side application explicitly knows that all data packets will pass through the cloud service 110. The appropriate settings must be input into the client-side application (e.g., the public network address and port number of the cloud service 110) or, in the alternative, a Proxy Auto-Configuration (PAC) file can used to configure the client-side application to download the those settings from a Web server. As a result, the client-side application will connect directly to the cloud service 110 when a user initiates a query using those settings such that the data packets originated by that user when he or she initiates a query will be pass through the cloud service 110 without that user being required to enter a user name and password to access the cloud service each time he or she initiates such a query. In other words, the client-side application is configured to automatically authenticate a user and provide that user with the service(s) of the cloud service 110 without further interaction from the user.

Also in the subnet 102 that utilizes an explicit proxy configuration, the router 116 is further configured to connect that subnet 102 to the cloud service 110 via the Internet. The router is also configured to perform Network Address and Port Translation (NAPT) processing on the data packets generated as part of a query, which includes transforming the private network address and port number of the GUI 112 that originated those data packets into the public network address and port number of that router 116. Accordingly, those data packets only include the public network address and port number of the router 116 when they reach the cloud service 110. And although that configuration prevents the specific user who originated data packets from being identified by the private network address of the GUI 112 from which that user originated those data packets, the specific subnet 102 from which that user originated those data packets can be indentified from the public network address of the router 116. As discussed above, that public network address uniquely identifies that router's 116 subnet 102 within the digital network 100. Thus, when the cloud service 110 receives data packets via the explicit proxy connection, it can at least identify a group of users according to the subnet 102 from which a data packet was originated. Identifying groups of users in that manner allows the cloud service 110 to apply different policies to different users on subnet-by-subnet basis.

3. Proxy Forwarding Configuration

In the subnet 102 that utilizes a proxy forwarding configuration (i.e., “Subnet D”), the subnet server 114 in that subnet 102 is further configured to act as an intermediary, or proxy, between the cloud service 110 and the GUIs 112 in that subnet 102. More specifically, the subnet server 114 is configured to intercept data packets originated from the GUIs 112 within that subnet 102, to establish a connection with the cloud service 110, and to direct those data packets to the cloud service 110 via that connection. When that connection is made, the subnet server 114 identifies the specific user that originated those data packets.

Also in the subnet 102 that utilizes a proxy forwarding configuration, the router 116 is further configured to connect that subnet 102 to the cloud service 110 via the Internet. The router is also configured to perform NAPT processing on the data packets generated as part of a query, which includes transforming the private network address and port number of the GUI 112 that originated those data packets into the public network address and port number of that router 116. Accordingly, those data packets only include the public network address and port number of the router 116 when they reach the cloud service 110. But because the subnet server 114 identifies the user that originated those data packets when the connection for transmitting those data packets is made with the cloud service, the cloud service 110 can uniquely identify the specific user that originated those data packets using the public network address of the router 116 in conjunction with that user information. Identifying specific users in that manner allows the cloud service 110 to apply different policies to different users on a granular, user-by-user basis.

B. Mobile Devices 104

The mobile device 104 may include substantially any computing device that is portable and that can access the Internet (e.g., Internet-capable laptop computers, tablet computers, netbooks, PDAs, smart phones, etc.). The mobile device 104 includes one or more CPUs that are configured to execute the instructions of a computer program, or software, and carry out the functions of that device. Such mobile devices 104 may be provided to a customer's employees so they can perform various tasks remotely from a customer site (e.g., a subnet 102). Accordingly, the mobile device 104 is configured to obtain electronic data communication with the cloud service 110 using a mobile VPN configuration that provides a secure connection with the cloud service 110.

To facilitate that secure connection, the mobile device 104 includes mobile client software that is configured to perform processes similar to those described above with respect to the firewalled VPN configuration, including encrypting and/or authenticating data packets and encapsulating them into a new data packet with a new header, wherein the new data packets include both the private network address of the mobile device 104 that originated them and the public network address of the network (not shown) via which that mobile device 104 accessed the Internet (e.g., a WiFi network, a cellular broadband network, etc.). That mobile client software is also configured to provide user information to the cloud service 110 that identifies the user originating the data packets being transmitted from the mobile device 104. Accordingly, when the cloud service 110 receives data packets via the mobile VPN connection, it can decrypt those data packets and uniquely identify the specific user that originated those data packets using the private network address of the mobile device 104 included in the data packets and the user information provided by the mobile client software. Identifying specific users in that manner allows the cloud service 110 to apply different policies to different users on a granular, user-by-user basis.

### C. Remote Hosts 106

Each remote host 106 includes an original content server that is configured to provide web-based content to users of the digital network 100. Each remote host 106 also includes one or more CPUs that are configured to execute the instructions of a computer program, or software, and carry out the functions of that device. Although not illustrated, the remote host 106 may also include a router, a name server, and one or more graphical user interfaces. But for the purposes of the present invention, the primary feature of concern for the remote hosts 106 is their provision of web-based content to users of the digital network 100.

It is that web-based content that is queried by users using GUIs 112 within the subnets 102. And it is that web-based content on which the cloud service 110 performs analyses as the corresponding data packets are being transmitted from the remote hosts 106 to the GUIs 112 within the subnets 102 in response to those queries. Such web-based content may include, for example, data that is useful to one or more users within a subnet 102 as well as data that is dangerous, inappropriate, or otherwise untrusted for communication to one or more users within a subnet 102.

### D. Administrative Workstation 108

The administrative workstation 108 may include substantially any suitable computing device that is capable of accessing the cloud service, directly or indirectly (e.g., Internet-capable personal or laptop computers, tablet computers, netbooks, PDAs, smart phones, etc.). The administrative workstation 108 includes one or more CPUs that are configured to execute the instructions of a computer program, or software, and carry out the functions of that device. The administrative workstation 108 is preferably in electronic data communication with the cloud service 110 using a secured, private connection, such as a VPN or WAN connection. The administrative workstation 108 includes functionality for performing various administrative tasks on and within the cloud service 110, such as those required to configure the various accesses to the cloud service 110 and the manage the service(s) provided by the cloud service 110.

### E. Cloud Service 110

The cloud service 110 includes at least one Network Operations Center (NOC) 118 and at least one data center 120, wherein each data center 120 includes a plurality of datapods 122. The NOC 118, data center 120, and datapods 122 operate together to perform, support, and enhance the service(s) provided by the cloud service 110, as discussed in more detail below.

1. NOC 118

The NOC 118 is configured to monitor and control the data center 120 and the datapods 122 and includes functionality for use by one or more of the service provider's authorized IT administrators to remotely monitor and control the data center 120 and the datapods 122. The NOC 118 is also configured to manage the general operations of the cloud service 110, such as sales, billing, reporting, and customer support functionality. That functionality can be accessed via the administrative workstation 108. The NOC 118 includes one or more CPUs that are configured to execute the instructions of a computer program, or software, and carry out the functions of that device.

The NOC 118 is further configured to connect the subnet servers 114 in the subnets 102 that use the firewalled VPN connection (i.e., “Subnet A” and “Subnet B”) to the appropriate datapods 122 (i.e., the nearest and/or least loaded datapods 122) so the M/A manager 322 in those datapods 122 can receive various information from those subnet servers 114 when different users log on to different GUIs 112 within those subnets 102. That information includes user information (i.e., user IDs), connection information (i.e., the public network addresses of the routers 116 within those subnets 102), GUI addresses (i.e., the private network address of the GUI 112 to which a user is logged on), and policy information (i.e., the identity of the policy that has been chosen by the customer for a user, or group of users). And that information can be sent to the M/A manager 322 from those subnet servers 114 either in real time for each user as it is logged or periodically in batch mode after it has been logged for a plurality of users.

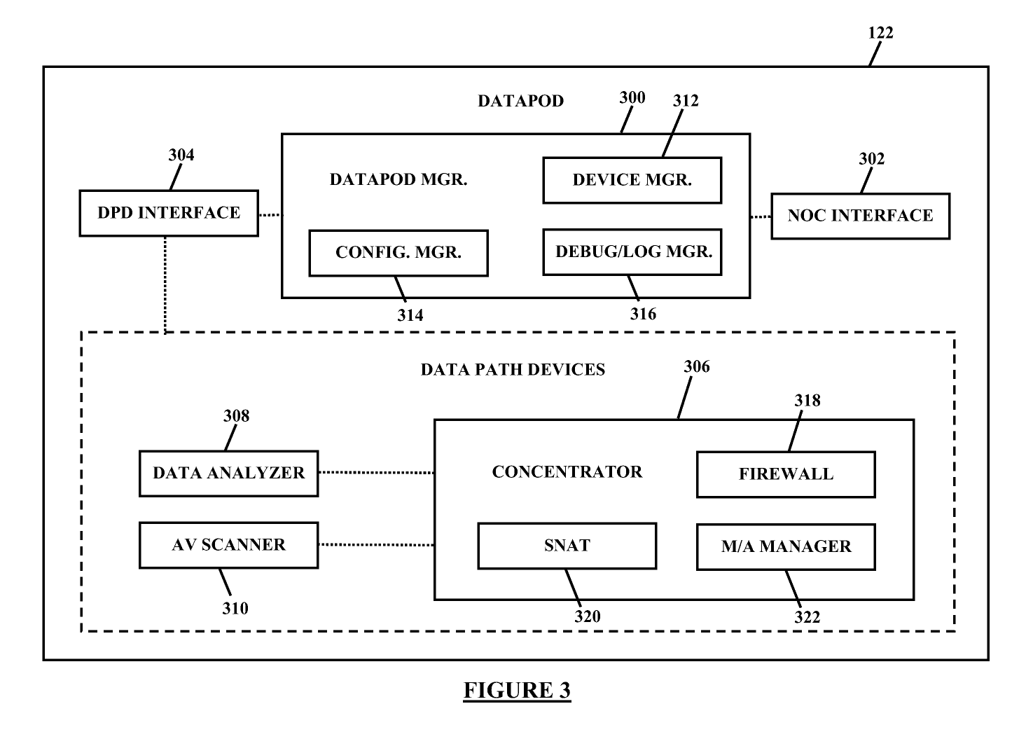

First, customers install an authentication agent on the subnet servers 114 in their respective subnets 102. Then, the customers register to receive the service(s) provided within the cloud service 110, at which point the authentication agent connects to the NOC 118. The NOC 118 then sends connection information to the authentication engine on the subnet servers 114, at which point the authentication engine connects the subnet servers 114 to the appropriate datapods 122. Using that connection, the subnet servers 114 will forward the user information, connection information, GUI addresses, and policy information to the datapods 122 so that, each time a user logs on to a different GUI 112 within the corresponding subnet 102, the M/A manager 322 can update the NAT mapping table 500 and SNAT mapping table 600 to include the most current information for uniquely identifying users. The M/A manager 322, NAT mapping table 500, and SNAT mapping table 600 are discussed in more detail below with respect to FIGS. 3, 5, and 6, respectively.

2. Routers 200 and 202

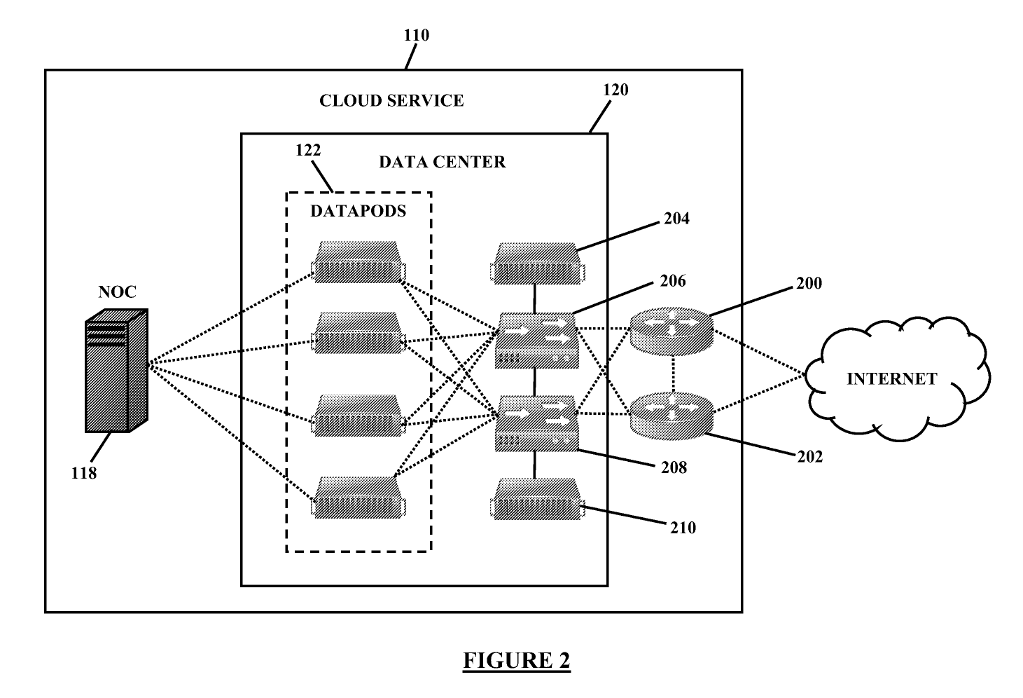

As illustrated in FIG. 2, the cloud service 110 also includes a master router 200 and a backup router 202 that utilize the Virtual Router Redundancy Protocol (VRRP), as described in RFC 3768, to increase the availability and reliability of the cloud service 110 using connection redundancy. More particularly, the master router 200 and backup router 202 are configured to operate as a single, “virtual” router, wherein only one router 200 or 202 performs actual routing at any given time. For example, if the master router 200 is routing data on behalf of the virtual router and fails, the backup router 202 will automatically replace it. Those routers 200 and 202 are configured to make routing decisions based on path, network policies, and/or rulesets, such as those backed by the Border Gateway Protocol (BGP). Each of those routers 200 and 202 includes one or more CPUs that are configured to execute the instructions of a computer program, or software, and carry out the functions of those devices.

3. Data Center 120

As further illustrated in FIG. 2, the data center 120 also includes one or more service delivery controllers (SDCs) 204, two or more cloud servers 206 and 208, and one or more VPN managers 210. Each of the SDC 204, the two or more cloud servers 206 and 208, and the one or more VPN managers 210 includes one or more CPUs that are configured to execute the instructions of a computer program, or software, and carry out the functions of those devices.

The SDC 204 is configured to load-balance data requests across the cloud servers 206 and 208 to achieve scalability and fault tolerance; to employ performance optimization techniques across the cloud servers 206 and 208 to improve the performance of the services provided by the cloud service 110; and to perform security checking, authentication, and content-based routing to implement the specific policies of different users and/or groups of users that are utilizing the cloud service 110. The two or more cloud servers 206 and 208 form a high-availability cluster, or failover cluster, that is configured to support the services of the cloud service 110 using server redundancy, similar to the connection redundancy discussed with respect to the master router 200 and backup router 202, so as to improve the availability and reliability of those services. And the VPN manager 210 is configured to provide functionality to authorized IT administrators to manage and customize the configuration parameters between the cloud service 110 and the specific subnets 102 secured by the firewalled VPN configuration (i.e., “Subnet A” and “Subnet B”) and to manage the way the datapods 122 process data traffic as it passes through the cloud service 110. The functionality provided by those devices 204-210 can be accessed and managed by authorized IT administrators from a single, central location, such as the administrative workstation 108.

The VPN manager 210 is also configured to maintain information regarding the load on each of the datapods 122 using a Domain Name System (DNS) and to balance loads across the cloud service 110 by redirecting new connections to the nearest datapod 122 with the least load using level 3 and/or level 4 (L3/L4) load balancing. More particularly, the VPN manager 210 maintains an aggressive state and monitors the health of each datapod 122 and controls the load to the corresponding datapod 122 as required to meet specific performance characteristics. Preferably, the VPN manager 210 controls that load as required to support at least 1.5 million transparent connections, 50,000 users, and a 1 Gbps transmission rate in each datapod 122. The information monitored by the VPN manager 210 is also used to identify potential and existing failure and/or failover scenarios in each datapod 122.

4. Datapods 122

As illustrated in FIG. 3, each datapod 122 includes a datapod manager 300, a NOC interface 302, a data path device (DPD) interface 304, a concentrator 306, a data analyzer 308, and an anti-virus (AV) scanner 310. The datapod manager 300 also includes a device manager 312, a configuration manager 314, and a debug/log manager 316. And the concentrator 306 also includes a firewall 318, a secured network address translator (SNAT) 320, and a metadata/authorization (M/A) manager 322. Each datapod 122 includes one or more CPUs that are configured to execute the instructions of a computer program, or software, and carry out the functions of that device and its various components 300-322.

a. Datapod Manager 300

The datapod manager 300 is configured to allow each datapod 122 to be controlled remotely from the NOC 118 via electronic data communications with one, central device in each datapod 122. More particularly, the datapod manager 300 interfaces the NOC 118 with the data path devices 306-310 in each datapod 122 so that those data path devices 306-310 can be remotely managed and configured via an administrative VLAN within the cloud service 110. The datapod manager 300 also collects debug and statistical information regarding the data transmitted via the data path devices 306-310. The device manager 312 is configured to provide functionality for managing the data path devices 306-310 (e.g., brining them in and out of service, upgrading their software, etc.); the configuration manager 314 is configured to provide functionality for configuring the data path devices 306-310 to operate in accordance with different policies for different users and/or groups of users; and the debug/log manager 316 is configured to provide functionality for pulling and archiving debug logs and statistics generated by the data path devices 306-310.

b. NOC Interface 302 and DPD Interface 304

The NOC interface 302 is configured to facilitate electronic data communication between the NOC 118 and the various services 312-316 of the datapod manager 300, thereby allowing the corresponding datapod 122 to be managed remotely from the NOC 118. And the DPD interface 304 is configured to facilitate electronic data communication between the various services 312-316 of the datapod manager 300 and the data path devices 306-310 within each datapod 122. Accordingly, the NOC interface 302 and DPD interface 304 facilitate electronic data communication between the NOC 118 and the data path devices 306-310 within each datapod 122 via the datapod manager 300, which allows the functionality of each datapod 122 to be managed and configured via a single, central device in each datapod 122 (i.e., the datapod manager 300).

c. Concentrator 306

Electronic data communication between each datapod 122 and the subnets 102 and remote hosts 106 is facilitated by the concentrator 306. The concentrator 306 is a physical device, or host, that is configured to accept connections from the subnets 102 that are registered to receive the service(s) provided within the cloud service 110. The concentrator 306 includes a firewall 318 that is configured to provide functionality for protecting the datapod 122 from external attacks, a SNAT 320 that is configured to provide functionality for performing both network address translation (NAT) processing and NAPT processing on data packets as those data packets pass through the datapod 122, and an M/A manager 322 that is configured to provide functionality for aggregating metadata and performing admission and connection control.

Because the provider of the cloud service 110 generally cannot control how a customer of those services will set up a subnet 102 and/or assign private network addresses within that subnet 102, it is possible that the cloud service 110 will receive data packets from different subnets 102 that are identified using identical private network addresses and/or identical user information. Accordingly, the concentrator 306 includes functionality for using different combinations of connection information, user information, private network addresses of GUIs 112, and public network addresses of subnets 102 (i.e., the public addresses of the routers 116 within those subnets 102) that is maintained by the M/A manager 322 to uniquely indentify specific users and/or groups of users and to associate each of those users and/or groups of users with a new private network address. The SNAT 320 assigns a new private network address to the data packets originated by each of those users and/or groups of users for use within the cloud service 110 to distinguish between different users and/or groups of users and to determine the type of analysis that will be performed on (i.e., determining the service(s) that will be provided to) the data packets originated by those users and/or groups of users. That functionality is described in more detail below with respect to the individual components 318-322 of the concentrator 306, and with respect to the data analyzer 308.

i. Firewall 318

The firewall 318 is configured to provide an additional layer of security to the subnets 102 and the could service 110 by providing a logical and/or physical separation between the data path devices 306-310 within each datapod 122 and untrusted sources of data within the digital network 100, such as the remote hosts 106, thereby protecting the elements 300-322 of each datapod 122 from external attacks. More particularly, the firewall 318 is configured to restrict data traffic by setting up tunnels for specific IP ports so as to only allow traffic originating from and/or destined for specific IP addresses and ports to pass through the concentrator 306. In that manner, the firewall 318 restricts the data traffic that passes through the cloud service 110 to that forwarded from or returning to the subnets 102 that customers have registered to receive the service(s) provided by within the cloud service 110. The firewall 318 is preferably configured to handle multiple different IP layer protocols corresponding to the different types of traffic being handled by the cloud service 110.

For example, the firewall 318 is preferably configured to handle the IPsec protocol for data traffic from GUIs 112 within the subnets 102 that use the firewalled VPN configuration to communicate with the cloud server 110 (i.e., “Subnet A” and “Subnet B”); the HTTP protocol for data traffic from GUIs 112 within the subnets that use the explicit proxy and proxy forwarding configurations to communicate with the cloud server 110 (i.e., “Subnet C” and “Subnet D”); and the SSL protocol for data traffic from mobile devices 104 that use the mobile configuration to communicate with the cloud server 110. That functionality allows the cloud service 110 to safely handle data from multiple different sources. Moreover, it may be provided by publicly available IP data control software, such as SkyCAP IP data control software (see, e.g., vpn.skycap.com for IPSec, proxy.skycap.com for HTTP, and webvpn.skycap.com for SSL).

The firewall 318 is also configured to apply a filter mark (e.g., an fwmark, a netfilter mark, etc.) to data packets received using the firewalled VPN configuration. When the cloud service receives a data packet in such a configuration, the firewall 318 utilizes the public network address provided on that data packet (i.e., the public network address of the router 116 of the subnet 102 from which that data packet was received) to identify the connection via which that data packet was received, and the concentrator 306 utilizes an IPsec engine to decapsulate that data packet to obtain the private network address of the GUI 112 from which that data packet originated. Together, that connection information and private network address uniquely identify the user that originated that data packet. And the firewall 318 applies a correspondingly unique filter mark to that data packet for uniquely identifying that data packet within the concentrator 306.

In other words, a filter mark is used in lieu of connection information and private network addresses within the concentrator 306 to uniquely identify data packets. Those filter marks are only part of the data packets while they are within the socket buffer that applied the filter mark, so they will not appear on the data packets outside of the concentrator 306. Such filter marks are preferable because they can be used without affecting the throughput or latency of data packet transmissions within the concentrator 306.

ii. SNAT 320

The SNAT 320 is configured to perform NAT processing on data packets as they are transmitted between the subnets 102 and the cloud service 110, and to perform NAPT processing on data packets as they are transmitted between the remote hosts 106 and the cloud service 110. More particularly, the SNAT 320 is configured to perform a one-to-one translation of each of the private network addresses of the GUIs 112 within each subnet 102 into a different private network address that is unique within the cloud service 110 identifies the specific user that originated the corresponding data packets, taking into account connection information and user information; the SNAT is configured to perform a one-to-one translation of the public network address of the router 116 within each subnet 102 into a private network address that is unique within the cloud service 110 and identifies the specific subnet 102 from which the corresponding data packets originated, taking into account connection information only; and the SNAT 320 is configured to perform a many-to-one translation of those NATted network addresses and their associated port numbers into a public network address and port number that identifies the could service 110 within the digital network 100. The SNAT 320 is also configured to perform the reverse of each of those translations.

For data packets transmitted to and from the subnets 102 that use the firewalled VPN configuration (i.e., “Subnet A” and “Subnet B”), the SNAT 320 performs both NAT processing and NAPT processing on data packets being transmitted from those subnets 102 to the remote hosts 106 via the cloud service 110. That NAT processing includes translating the private network address of the GUI 112 that originated the data packets into a different private network address that is unique within the cloud service and specific to the user that originated the corresponding data packets, and that NAPT processing includes translating that NATted private network address and its associated port number into a public network address and port number that are unique within the digital network 100 and identify the could service 110 as the source of those data packets when they are transmitted to a remote host 106. The SNAT 320 also performs the reverse of both of those translations, in the reverse order, on the data packets that are returned from the remote hosts 106 in response to those transmissions. The SNAT 320 processes data packets transmitted to and from the mobile device 104 in a similar manner.

For data packets transmitted to and from the subnet 102 that uses the explicit proxy configuration (i.e., “Subnet C”), the SNAT 320 also performs both NAT processing and NAPT processing on data packets being transmitted from that subnet 102 to the remote hosts 106 via the cloud service 110. That NAT processing includes translating the public network address of the router 116 within the subnet 102 from which the data packets originated into a private network address that is unique within the cloud service 110 and specific to the subnet 102 from which those data packets originated, and that NAPT processing includes translating that NATted public network address and its associated port number into a public network address and port number that are unique within the digital network 100 and identify the could service 110 as the source of those data packets when they are transmitted to a remote host 106. The SNAT 320 also performs the reverse of both of those translations, in the reverse order, on the data packets that are returned from the remote hosts 106 in response to those transmissions.

For data packets transmitted to and from the subnet 102 that uses the proxy forwarding configuration (i.e., “Subnet D”), the SNAT 320 only performs NAPT processing on data packets being transmitted from that subnet 102 to the remote hosts 106 via the cloud service 110. That NAPT processing includes translating the public network address and port number of the router 116 of the subnet 102 from which those data packets originated into a public network address and port number that identifies the could service 110 as the source of those data packets when they are transmitted to a remote host 106. The SNAT 320 does not perform NAT processing to provide the data packets with a private network address that is unique within the cloud service because, when the connection between that subnet 102 and the cloud service 110 is made, the subnet server 114 within that subnet 102 identifies the specific user that originated those data packets. Accordingly, the cloud service 110 can uniquely identify that specific user within the cloud service based on that connection. And because data packets that are returned from the remote hosts 106 in response to those transmissions via the same connection, only the reverse NAPT processing needs to be performed on those return data packets.

As discussed above with respect to the subnets 102, the private network addresses of the GUIs 112 are utilized within each subnet 102 to separately identify the different GUIs 112 within that subnet 102, and the public network addresses of the routers 116 within those subnets 102 are utilized within the digital network 100 to uniquely identify the different subnets 102 within the digital network 100. Similarly, the private network addresses into which those private and public network addresses are NATted by the SNAT 320 are used within cloud service 110 to uniquely identify the specific users that are originating data packets. And the data analyzer 308 utilizes those NATted network addresses to determine the type of analysis to perform on the data packets originated by different users by associating those network addresses with the policies chosen for those users. In that manner, the data analyzer 308 performs as a proxy. Accordingly, the private network addresses of the GUIs 112 that are utilized to identify specific users within each subnet 102 are referred to hereinafter and above as “GUI addresses,” the public network addresses of the routers 116 that are utilized to indentify the specific subnets 102 within the digital network 100 are referred to hereinafter as “subnet addresses,” and the different private network addresses into which those GUI addresses and subnet addresses are NATted within the cloud service 110 are referred to hereinafter as “proxy addresses.”

The public network addresses of the remote hosts 106 are utilized by the cloud service 110 in conjunction with an associated destination port number to identify the destination of the data packets the cloud service 110 receives from the different GUIs 112 within each subnet 102. And as discussed above, the cloud service 110 utilizes its own public network address and source port numbers to identify the source of those data packets when those data packets are transmitted from the cloud service 110 to the remote hosts 106. The cloud service 110 also utilizes the public network addresses and source port numbers of the remote hosts 106 to identify the source of the data packets it receives back from the remote hosts 106 in response to the data packets it transmits to those remote hosts 106, while the remote hosts 106 utilize the public network address and destination port number of the cloud service 110 to identify the destination of the data packets it transmits back to the cloud service 110 in response to the data packets it receives from the cloud service 110. Accordingly, the public network addresses and port numbers that are utilized to identify the remote hosts 106 as destinations and sources of data packets are referred to hereinafter as “remote host addresses” and “remote host port numbers”, respectively, and the public network address and port numbers that are utilized to identify the cloud service as a source and destination of data packets are referred to hereinafter as “the cloud address” and “cloud port numbers”, respectively.

Both the GUI addresses and the proxy addresses are considered “private” network addresses because they utilize IP addresses within ranges that are reserved for use within private networks (e.g., 10.0.0.0 through 10.255.255.255, 172.16.0.0 through 172.31.255.255, and 192.168.0.0 through 192.168.255.255). By contrast, the subnet addresses, remote host addresses, and cloud address are considered “public” network addresses because they utilize IP addresses within ranges that are globally routable throughout the digital network 100 (e.g., IP addresses not within the ranges of 10.0.0.0 through 10.255.255.255, 172.16.0.0 through 172.31.255.255, and 192.168.0.0 through 192.168.255.255). The SNAT 320 preferably utilizes the range of private IP addresses with the largest number of possible addresses (e.g., 10.0.0.0 through 10.255.255.255) during the NAT process so as to reduce the risk of address exhaustion within the cloud service 110. Moreover, the larger the number of possible addresses that are available for use within the cloud service 110, the larger the number of possible customers the cloud service 110 can serve via a multi-tenant software architecture.

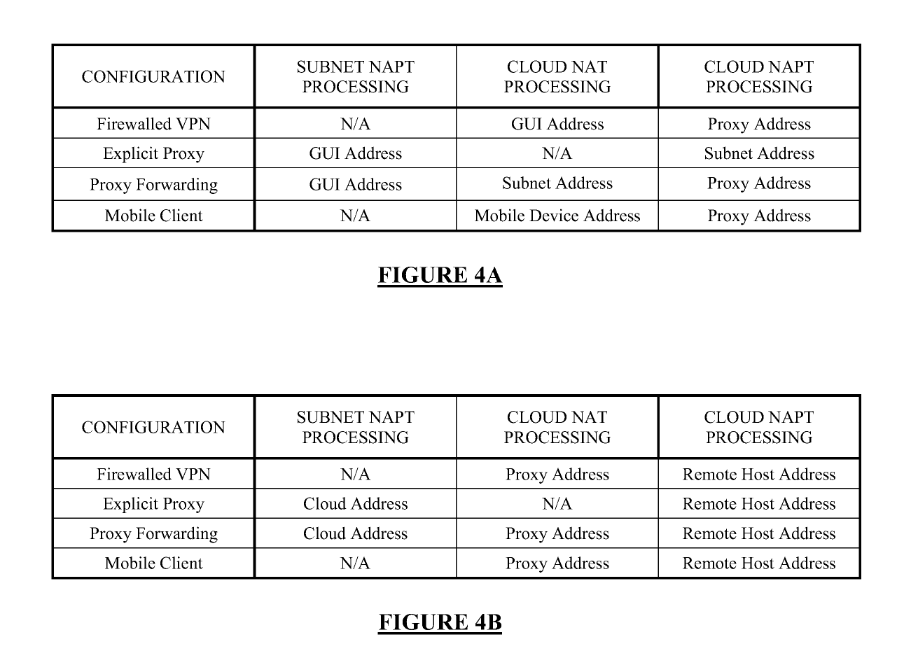

As illustrated in FIGS. 4A and 4B, the types of NAT and NAPT processing applied to data packets and the device that performs that processing depends on the connection configuration a device has with the cloud service. FIG. 4A identifies which addresses receive which type of translation, as well as the location of at which that translation occurs, for data packets being transmitted to a remote host 106 from a subnet 102 or a mobile device 104 (i.e., data packet forward path translations). And FIG. 4B identifies which addresses receive which type of translation, as well as the location of at which that translation occurs, for data packets being transmitted from a remote host 106 back to a subnet 102 or a mobile device 104 (i.e., data packet return path translations). In those figures, the addresses on which NAPT processing is performed by the router 116 in a subnet 102 are identified in the column labeled “Subnet NAPT Processing;” the addresses on which NAPT processing is performed by the SNAT 320 in the cloud service 110 are identified in the column labeled “Cloud NAT Processing;” and the addresses on which NAPT processing is performed by the SNAT 320 in the cloud service 110 are identified in the column labeled “Cloud NAPT Processing.”

Turning to FIG. 4A, NAPT processing is performed by the router 116 in a subnet 102 in the explicit proxy and proxy forwarding configurations before transmitting a data packet to the cloud service 110. That NAPT processing includes a many-to-one translation of GUI addresses to a subnet address such that those GUI addresses are hidden behind the subnet address. NAT processing is then performed by the SNAT 320 in the cloud service 110 in a one-to-one translation of each subnet address (i.e., the NAPTed GUI addresses) to a proxy addresses in the proxy forwarding configuration, while no NAT processing is performed on the subnet addresses subnet in the explicit proxy configuration. Accordingly, NAPT processing is performed by the SNAT 320 in the cloud service in a many-to-one translation of subnet addresses to cloud addresses in the explicit proxy configuration and of proxy addresses to the cloud address in the proxy forwarding configuration. That NAPT processing hides those subnet addresses and proxy addresses behind the cloud address.

In the firewalled VPN and mobile VPN configurations, data packets are tunneled directly to the cloud service 110 without performing a NAPT process on those data packets at a the router 116 of a subnet 102 or elsewhere. Accordingly, NAT processing is performed by the SNAT 320 in the cloud service 110 in a one-to-one translation of each GUI address to a proxy address in the firewalled VPN configuration and of the private network address of the mobile device 104, hereinafter “the mobile device address,” to a proxy address in the mobile VPN configuration. NAPT processing is then performed by the SNAT 320 in the cloud service 110 in a many-to-one translation of each proxy address (i.e., the NATted GUI addresses and mobile device addresses) to a cloud address in the firewalled VPN and mobile VPN configurations. That NAPT processing hides those proxy addresses behind the cloud address.

Turning to FIG. 4B, NAPT processing is performed by the SNAT 320 in the cloud service 110 in each connection configuration when a data packet is received from a remote host 106. That NAPT processing includes a one-to-one translation of a remote host address to proxy addresses in the firewalled VPN and mobile VPN configurations, of a remote host address to a proxy address in the proxy forwarding configuration, and of a remote host address to the cloud address in the explicit proxy configuration. Accordingly, NAT processing is then performed by the SNAT 320 in the cloud service 110 in a one-to-one translation of a proxy address (i.e., the NAPTed remote host address) to a GUI address in the firewalled VPN configuration, of a proxy address to the cloud address in the proxy forwarding configuration, and of a proxy address to a mobile device address in the mobile VPN configuration.

In the explicit proxy configuration, data packets are transmitted back to the subnet 102 without performing NAT processing with the SNAT 320 in the cloud service 110. Thus, data packets arrive at the subnets 102 in both the explicit proxy and proxy forwarding configurations with the cloud address. NAPT processing is then performed by the router 116 in a subnet 102 in a many-to-one translation of the cloud address to GUI addresses. In that manner, the corresponding data packets can be routed back to the specific GUI 112 or mobile device identified as their destination.

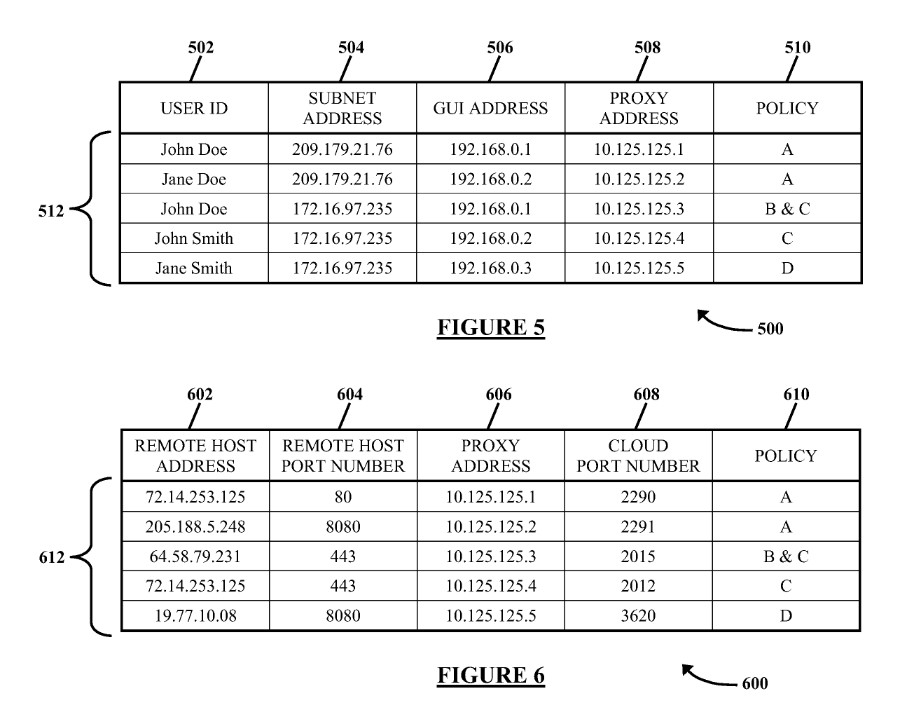

As illustrated in FIG. 5, the SNAT 320 utilizes a NAT mapping table 500 to determine how to translate between GUI addresses and proxy addresses when performing NAT processing. The NAT mapping table 500 comprises a column 502 that includes user information, a column 504 that includes connection information, a column 506 that includes GUI addresses, a column 508 that includes proxy addresses, and a column 510 that includes policy information. Although not illustrated, the NAT mapping table 500 may also comprise columns that include other information, such as transfer protocols, source port numbers (i.e., port numbers corresponding to the ports of the GUIs 112 from which the data packets were received), remote host port numbers (i.e., destination port numbers), remote host addresses, numbers of data packets, byte counts, timestamps, last packet seen, connection timeouts, and data packet times to live (TTLs). And in the explicit proxy configuration, the column 502 that includes user information may be omitted, because the cloud service 110 only applies policies on a subnet-by-subnet basis in that configuration.

The NAT mapping table 500 also includes a plurality of rows 512, each of which corresponds to a different user. The information in each row identifies various attributes of the data packets transmitted between the cloud service 110 and the mobile device 104 or a specific GUI 112 within a specific subnet 102. More particularly, the user information in each row 512 identifies the log-on information of the user logged on to the mobile device 104 or GUI 112 from which a data packet was received (e.g., a user name); the connection information in each row 512 identifies the subnet address of the subnet 102 or other network from which that data packet was received; the GUI address in each row 512 identifies the private network IP address of the mobile device 104 or GUI 112 at which that user is logged on; the proxy address in each row 512 identifies the private network IP address assigned to that user for use within the cloud service 110; and the policy information in each row 512 identifies the policy chosen for that user that will be used by the data analyzer 308 to determine the type of analysis to perform on the data packet.

In the firewalled VPN configuration, the user information, connection information, GUI addresses, and policy information are received from a subnet server 114 within a corresponding subnet 102 (i.e., “Subnet A” or “Subnet B”) after a user logs on to a GUI 112 within that subnet 102. The authentication agent within that subnet server 114 provide that information to the M/A manager 322. In the explicit proxy configuration, connection information and policy information are received from the client-side application on the subnet server 114 within the corresponding subnet 102 (i.e., “Subnet C”) when that subnet server 114 makes a connection with the cloud service 110. Similarly, in the proxy forwarding configuration, connection information and user information are received from the proxy functionality on the subnet service 114 within the corresponding subnet 102 (i.e., “Subnet D”) when that subnet server 114 makes a connection with the cloud service 110. And in the mobile VPN configuration, user information, connection information, GUI addresses, and policy information are received from the mobile client software on the mobile device 104 when the mobile device 104 makes a connection with the cloud service 110.

In the explicit proxy and proxy forwarding configurations, policy information is provided when the customer registers with the service provider and configures the client-side application or proxy functionality on its subnet server(s) 114. In the firewalled VPN and mobile VPN configurations, the GUI addresses also are received as part of the original headers of the data packets that are received from a mobile device 104 or GUI 112. And in all four connection configurations, the subnet addresses also are received with the data packets that are received from a mobile device 104 or GUI 112, either as part of VPN processed header in the firewalled VPN and mobile VPN configurations or as part of a NAPTed header in the explicit proxy and proxy forwarding configurations.

That information is used by the M/A manager 322 to populate the NAT mapping table 500 as it is received/assigned so the firewall 318 can use the NAT mapping table 500 to assign the appropriate filter marks to data packets; the SNAT 320 can use the NAT mapping table 500 to assign the appropriate proxy address to data packets; and the data analyzer 308 can use the NAT mapping table 500 to filter data packets and apply the appropriate policy-based analysis to perform on those data packets. The firewall 318 assigns filter marks based on the connection information for the connection via which a data packet was received, and the data analyzer 308 determines the type of analysis to perform on a data packet based on the policy information associated with the proxy address assigned to that data packet. The translation performed by the SNAT 320, however, depends on the connection configuration used to transmit that data packet to the cloud service 110.

In the firewalled VPN and mobile VPN configurations, a user is uniquely identified by the unique combination of connection information and GUI address received as part of a data packet. That unique combination of connection information and GUI address is matched to the corresponding combination of information in the NAT mapping table 500, which is also associated with user information and policy information within the NAT mapping table 500. A unique proxy address is then associated with that information—in particular, the policy information—so that the data analyzer 308 will know which type of analysis to perform on the corresponding data packet based on that proxy address. Because that unique combination of information allows users to be identified on a user-by-user basis, the firewalled VPN and mobile VPN configurations allow proxy addresses to be assigned on a user-by-user basis. Thus, the data analyzer 308 can analyze data traffic on a granular, user-by-user basis using those user-specific proxy addresses, which allows it to employ a multi-tenant software architecture to provide different services to different users within the same subnet 102 and/or different subnets 102.

In the explicit proxy configuration, a user cannot be uniquely identified because the GUI address of the GUI 112 at which that user originated a data packet is masked behind the subnet address of the subnet 102 to which that GUI 112 belongs. Nevertheless, that subnet is uniquely identified with the connection information received as part of the data packet. That connection information is matched to the connection information in the NAT mapping table 500, which is also associated with policy information within the NAT mapping table 500. A unique proxy address is then associated with that information—in particular, the policy information—so that the data analyzer 308 will know which type of analysis to perform on the corresponding data packet based on that proxy address. Because that connection information only allows users to be identified on a subnet-by-subnet basis, the explicit proxy configuration only allows proxy addresses to be assigned to groups of users within the corresponding subnet 102. Nevertheless, the data analyzer 308 can analyze data traffic on a subnet-by-subnet basis using those user-specific proxy addresses, which allows it to employ a multi-tenant software architecture to provide different services to different subnets 102.

In the proxy forwarding configuration, although the GUI address of the GUI 112 at which a user originated a data packet is masked behind the subnet address of the subnet 102 to which that GUI 112 belongs, that user can still be uniquely identified. That is because user information for that user is transmitted to the cloud service 110 when a connection is made between the corresponding subnet 102 and the cloud service 110, as discussed above. And connection information is received as part of the data packet transmitted via that connection, as also discussed above. Accordingly, when the cloud service 110 receives a data packet from that subnet 102, the user can be uniquely identified by the unique combination of user information and connection information.

That unique combination of user information and connection information is matched to the corresponding combination of information in the NAT mapping table 500, which is also associated with policy information within the NAT mapping table 500. A unique proxy address is then associated with that information—in particular, the policy information—so that the data analyzer 308 will know which type of analysis to perform on the corresponding data packet based on that proxy address. Because that unique combination of information allows users to be identified on a user-by-user basis, the proxy forwarding configuration also allows proxy addresses to be assigned on a user-by-user basis. Thus, the data analyzer 308 also can analyze data traffic on a granular, user-by-user basis using those user-specific proxy addresses, which allows it to employ a multi-tenant software architecture to provide different services to different users within the same subnet 102 and/or different subnets 102.

In FIG. 5, for example, there are two users identified with both the user information “John Doe” and the GUI address “192.168.0.1” within two different subnets 102—the subnet 102 that corresponds to subnet address “209.179.21.76” and the subnet 102 that corresponds to subnet address “172.16.97.235.” Those two users are distinguished from each other based on the connection via which those users are communicating with the cloud service 110, and those two users are assigned different proxy addresses—proxy address “10.125.125.1” and proxy address “10.125.125.3”—based on that distinction. As a result, each user within each subnet 102 is assigned a proxy address different from any other user within his/her own subnet 102 as well as any user within any other subnet 102, thereby allowing the cloud service 110 to identify and provide services to each of those users on a user-by-user basis. That functionality is particularly useful when, as illustrated in the example of FIG. 5, different subnets 102 are using the same range of IP addresses as their GUI addresses.

It is also possible for multiple users to be associated with the same policy, depending on a customer's preferences. In FIG. 5, for example, the users identified with the user information “John Doe” and “Jane Doe” and subnet address “209.179.21.76” are both associated with the same policy (i.e., the policy defined by policy information “A”). Similarly, the users identified with the user information “John Doe” and “Jane Smith” and subnet address “172.16.97.235” are both associated with the same policy (i.e., the policy defined by policy information “C”). Nevertheless, the user identified with the user information “John Doe” and subnet address “172.16.97.235” is also associated with a different policy (i.e., the policy defined by policy information “B”). Accordingly, group policies can be defined for groups of users by assigning associating the same policy information with multiple users, and multiple policies can be assigned to the same user by associated multiple instances of policy information with that user.

As illustrated in the example of FIG. 5, each different combination of user information and connection information has a different proxy address such that no two users have the same proxy address, thereby allowing the cloud service 110 to quickly and accurately distinguish between different users. In the explicit proxy configuration, however, neither the user information nor the GUI address for a user would be available. Accordingly, a single proxy address would be assigned to the subnet 102 in which those users are performing data queries such that the same policy would be applied to those users based on the policy information associated with that proxy address. Thus, any subnet 102 that uses the explicit proxy configuration will effectively perform as if the same policy had been chosen for each user within that subnet 102.

Nevertheless, the values in the NAT mapping table 500 may change based on which GUI 112 a user logs on to and which subnet 102 that GUI 112 belongs to, the latter of which determines the connection information. Accordingly, the M/A manager 322 maintains a log of the different connection information for different customers (e.g., the different subnet addresses of the subnets 102 maintained by different customers) and utilizes it to populate the NAT mapping table 500 so users can be uniquely identified regardless of the subnet at which they log on to a GUI 112. In the NAT mapping table 500 of FIG. 5, for example, a third connection (not shown) might correspond to the same customer as the connection made via subnet address “172.16.97.235” such that, if the user identified with user information “John Doe” logs off of the connection made via subnet address “172.16.97.235” and logs on to a GUI 112 via that third connection (i.e., a GUI 112 in a different subnet), that user will already be associated with that customer so he/she can still be distinguished from the user identified with the user information “John Doe” logged on to a GUI 112 with the connection made via subnet address “209.179.21.76.”

As the discussion above demonstrates, the NAT mapping table 500 includes all of the information required to identify the unique source of outgoing data packets from different subnets 102 and the unique destination of incoming data packets being returned to those subnets 102. Moreover, it includes all of the information required to determine which services should be provided to which data packets on a subnet-by-subnet, policy-by-policy, and/or user-by-user basis. In the firewalled VPN, proxy forwarding, and mobile VPN configurations, that determination can be made on a user-by-user basis even where two or more different users in different subnets 102 have the same user information and GUI address. And because both the concentrator 306 and the data analyzer 308 rely on the information within that table to support their respective functionality, each may maintain its own respective copy of the NAT mapping table 500.

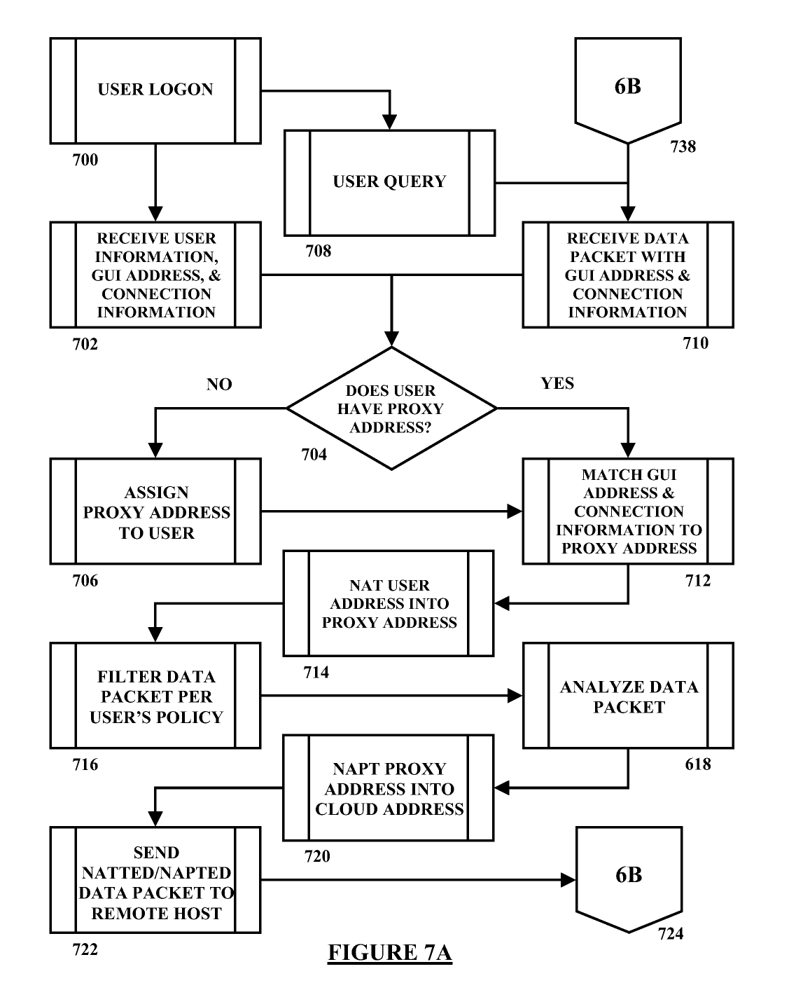

As illustrated in FIG. 6, the SNAT 320 utilizes a NAPT mapping table 600 to determine how to translate between proxy addresses and remote host addresses when performing the NAPT process. The NAPT mapping table 600 comprises a column 602 that includes remote host addresses (e.g., peerip), a column 604 that includes remote host port numbers (e.g., peerport), a column 606 that includes proxy addresses (e.g., mymappedip), a column 608 that includes cloud port numbers (e.g., mymappedport), and a column 610 that includes policy information. Although not illustrated, the NAPT mapping table 600 may also comprise columns that include other information typically of conventional IPv4 NAPT mapping tables 600, such as source port numbers (e.g., myport), GUI addresses (e.g., myip), mapped remote host addresses (e.g., peermappedip), and mapped remote host port numbers (e.g., peerport). The latter two types of information are not required in the NAPT mapping table 600 of the present invention because the SNAT 320 only performs NAPT on the source information, which is sometimes referred to as source NAPT.

The NAPT mapping table 600 also includes a plurality of rows 612, each of which corresponds to a different user. The information in each row identifies various attributes of the data packets transmitted between the cloud service 110 and the remote hosts 106. More particularly, the remote host address in each row 612 identifies the public network IP address of the remote host 106 to which a data packet is to be transmitted; the remote host port number in each row 612 identifies the destination port of the remote host 106 to which that data packet is to be transmitted; the proxy address in each row 612 identifies the private network IP address assigned to a user for use within the cloud service 110; the cloud port number in each row 612 is a unique value used to match return data packets to the user that queried them from a remote host 106; and the policy information in each row 612 identifies the policy chosen for that user that will be used by the data analyzer 308 to determine the type of analysis to perform on the return data packets.

The remote host addresses and remote host port numbers are received as part of the original headers of the data packets that are received from the remote hosts 106. The proxy addresses are those that were assigned to the data packets when the SNAT 320 performed NAT processing on the data packets after those data packets were received from a mobile device 104 or subnet 102. The cloud port numbers are assigned to the proxy addresses when the SNAT 320 performs the NAPT process on the data packets that are to be transmitted to the remote hosts 106. And the policy information is the same policy information that was associated with the corresponding proxy address in the NAT mapping table 500. That information is used by the M/A manager 322 to populate the NAPT mapping table 600 as it is received/assigned.

In the NAPT mapping table 600 of FIG. 6, the filter marks maintain the same relation with the proxy addresses that they have in the NAT mapping table 500 of FIG. 5 so that the same policies will be applied to the data packets being returned to the associated users that were applied to the data packets being transmitted by those users. In FIG. 5, for example, data packets transmitted to a remote host 106 by the user identified with proxy address “10.125.125.3” will be analyzed by the data analyzer 308 according to the policy associated with policy information “B & C” before reaching that remote host 106. And in FIG. 6, data packets transmitted to the GUI 112 being utilized by the user identified with proxy address “10.125.125.3” will also be processed within the cloud service 110 according to the policy associated with policy information “B & C” before reaching that GUI 112. Thus, a user's unique proxy address not only allows the cloud service 110 to quickly and accurately distinguish between different users for the purpose of determining the type of policy to apply to data packets received from different users in different subnets 102, it also allows the cloud service 110 to determine the type of policy to apply to data packets received from remote hosts 106 based on the destination of those data packets, as defined by those GUI addresses in conjunction with their respective cloud port numbers.

Cloud port numbers are assigned to user numbers as part of the NAPT process performed by the SNAT 320 in order to avoid ambiguity in handling data packets that are returned from the remote hosts 106 in response to queries initiated at different GUIs 112. The SNAT 320 alters the NATted headers of the data packets to include those cloud port numbers and maintains those altered port in the NAPT mapping table 600. As discussed above, those headers will have bee NATted either by the SNAT 320 in the firewalled VPN and mobile VPN configurations, by the router 116 in a subnet 102 in the explicit proxy configuration, or by both the SNAT 320 and a router 116 in a subnet in the proxy forwarding configuration. The SNAT 320 also translates the proxy addresses in the NATted headers into the cloud address in the firewalled VPN, proxy forwarding, and mobile VPN configurations; and translates the subnet addresses in the NATted headers into the cloud address in the explicit proxy configuration. The NAPT processing completes a many-to-one translation of the proxy addresses and subnet addresses.

The result of the associations made in the NAPT mapping table 600 is to provide a one-to-one relationship between each different proxy address and each proxy port address. Because different users or groups of users are identified by their proxy address, they can also be identified by the corresponding proxy port address. Thus, when data packets are returned to the cloud service 110 by the remote hosts 106 in response to data packets transmitted by the GUIs 112 within the different subnets 102, the cloud service can quickly and accurately identify the specific GUI 112 to which to transmit those return data packets. Moreover, the data analyzer 308 can also use those proxy addresses to determine which policy to apply to those return data packets before transmitting them to the identified GUI 112.

The NAPT processing performed by the SNAT 320 is consistent with the process set forth, for example, in RFC 2663. The NAT processing performed by the SNAT 320, however, is unique to the present invention. More particularly, the NAT process performed by the SNAT 320 does not alter higher level header information, such as TCP and/or UDP port numbers. Instead, it performs a one-to-one translation between GUI addresses or subnet addresses and proxy addresses without altering that higher level information, thereby making that process faster and more efficient than NAPT processing. And filter marks, rather than port numbers and IP addresses, are utilized by the concentrator 306 to filter the data packets within that device.

Another unique feature of the present invention is the use of two different translation processes—NAT and NAPT—within the cloud service 110. In the firewalled VPN configuration, for example, data packets are subjected to the NAT process, in-line analysis (e.g., AV scanning, dynamic real-time rating (DRTR), content filtering, etc.), and the NAPT process as they are transmitted from a GUI 112 to a remote host 106 via the cloud service 110. And return data packets are subjected to those same processes in the reverse order as they are transmitted from a remote host 106 back to a GUI 112 via the cloud service 110. Conventionally, only the NAPT process is performed.

iii. M/A Manager 322

The M/A manager 322 is configured to aggregate metadata within the cloud service 110 and perform admission and connection control. In the firewalled VPN and mobile VPN configurations, for example, the M/A manager 322 is configured to admit VPN connections only from subnets 102 registered and mobile devices 104 to receive the service(s) provided within the cloud service 110 (i.e., registered customers and their respective users), to terminate VPN connections with subnets 102 where the traffic transitions between encrypted and unencrypted, to filter out any unauthorized and/or compromised connections, and to ensure the appropriate services are provided to the appropriate users, or groups of users, within each subnet 102. The M/A manager 322 communicates with the data analyzer 308 to convey the data in the NAT mapping table 500 and NAPT mapping table 600 to that device as required for it to properly apply the appropriate policies to data packets. The M/A manager 322 also maintains the NAT mapping table 500 and NAPT mapping table 600 and keeps them in synch so that they can be used to reliably and repeatably transmit data packets back and forth between subnets 102 and remote hosts 106 via the cloud service 110.

Continuing with the example of the firewalled VPN and mobile VPN configurations, the M/A manager 322 communicates with the data analyzer 308 as required to complete user authorizations, to log the connection information received in authentication headers, and to log the GUI addresses received in original headers; communicates with subnet servers 114 with in the subnets 102 as required to obtain GUI addresses that have been associated with user information for users logged on to GUIs 112 within those subnets 114 with the associated GUI addresses; communicates with the configuration manager 314 as required to associate a specific user with a specific policy and, therefore, a specific proxy address; communicates with the SNAT 320 as required to convey the user information, connection information, GUI addresses, proxy addresses, and policy information that are associated with the different users for use in performing the NAT and NAPT processes; and communicates with the data analyzer 308, the AV scanner 310, and/or the other content analyzing device(s) to apply the appropriate services to data packets. The M/A manager 322 is also configured to allow the information it handles to be queried when the cloud service 110 is accessed using the firewalled VPN or mobile VPN configuration. In that manner, the M/A manager 322 maintains and shares all of the information required to route data packets to and from the cloud service 110, as well as to filter to the appropriate services within the cloud service 110.

d. Data Analyzer 308

The data analyzer 308 is configured to perform as a proxy server that both filters and analyzes data packets as they pass through the cloud service 110. In the firewalled VPN and mobile VPN configurations, for example, the data analyzer 308 is configured to authenticate users using, for example, 407 proxy authentication based on its communications with the M/A manager 322; to strip connection information from authentication headers and communicate it to the M/A manager 322 for association with the appropriate VPN connection for use in identifying specific users logged on to specific GUIs 112 within specific subnets 102; and to provide the appropriate services to data packets as they pass through the cloud service 110 in accordance with the user-specific policies chosen for those users by customers.

Continuing with the example of the firewalled VPN and mobile VPN configurations, the data analyzer 308 is configured to perform in-line analysis of data packets in accordance with user-specific policies, such as DRTR and content filtering, after filtering those data packets by policy. Different services may be provided to different users, or groups of users, depending on the policy or policies associated with those users, or groups of users. Those services are determined based on the proxy addresses assigned to the data packets, which correspond to the policy information that defines those services. Accordingly, the data analyzer 308 performs the actual service(s) of the cloud service 110 for which customers are registered. The services that are provided are logged by the data analyzer 308 and communicated to a log aggregator at the NOC 118 via the M/A manager 322.

In the explicit proxy configuration, the GUIs 112 in a subnet 102 are explicitly configured to use a proxy server, meaning that the browser on each of the GUIs 112 knows that all queries will pass through the data analyzer 308. Accordingly, the browser is given the IP address and port number of the data analyzer 308 (i.e., of the cloud service 110), or a Proxy Auto-Configuration (PAC) file is used to configure the browser to download the appropriate settings from a Web server. Thus, when a user initiates a query at a GUI 112, the browser connects to the cloud service 110 and sends the query through the data analyzer 308. A disadvantage of that proxy configuration is that each GUI 112 must be properly configured to use the data analyzer 308, which might not be feasible in a large organization.

In the proxy forwarding configuration, the GUIs 112 in a subnet 102 do not know the traffic is being processed by a proxy other than the subnet server 114. Accordingly, to enable the data analyzer 308 to intercept traffic sent to it, users must create a service and define it as transparent. The service is configured to intercept traffic for a specified port, or for all IP addresses on that port. A transparent HTTP proxy, for example, typically intercepts all traffic on port 80. To make sure that the appropriate traffic is directed to the data analyzer 308, hardware such as a Layer-4 switch or a WCCP router is utilized, or the data analyzer 308 can utilize a software bridge that can redirect selected traffic to the data analyzer 308. As discussed above, traffic redirection is managed based on the polices associated with proxy addresses.

e. AV Scanner 310

The AV scanner 310 is configured to scan the data packets for viruses as they pass through the cloud service 110. That scanning may occur separate from or in addition to the in-line services provided by the data analyzer 308. Whether or not such scanning is performed may be determined based on filtering using filter marks, or even based on web addresses and/or IP addresses that are identified as being untrustworthy or harmful.

As demonstrated by the foregoing description, the various elements 300-322 of each datapod 122 operate together to uniquely identify data packets according to the specific user that originated them and to perform in-line analysis on them according to a specific policy associated with that user. In the firewalled VPN and mobile VPN configurations, the unique combination of NAT processing and NAPT processing allows each datapod 122 to apply those policies on a user-by-user basis, even when different subnets 102 use the same GUI addresses and the same user information to identify the user that originated the data packets. In other words, those processes allow each datapod 122 to distinguish between data packets with overlapping private network addresses within the tunneled traffic flowing through the cloud service 110 so that a large number of customers, and their respective users, can be served with each datapod 122. Accordingly, each datapod 122 is particularly suited for use in providing services using a multi-tenant software architecture, wherein multiple customers can be served with a single instance of software within each datapod 122.

In addition, both the in-line analysis and the other process that occur within the datapods 122 are transparent to the users within the subnets 102 and the remote hosts 106, further making the datapods 122 particularly suitable for providing cloud services. Each datapod 122 is autonomous and modular such that datapods 122 can be added or removed as required to handle larger and smaller numbers of customers, respectively. The VPN manager 210 within the data center 120 communicates with the different datapods 122 so as to optimize throughput and maintain the optimum performance characteristics of each datapod 122, regardless of the number of datapods 122 being employed within the cloud service 110. Thus, the datapods 122 of the present invention not only overcome the shortcomings of the prior art with respect to the use of multi-tenant software architectures to provide cloud services, they overcome those shortcomings with a highly scalable solution that is easy to deploy, configure, and manage.

### F. Forward Multi-Tenant Traffic

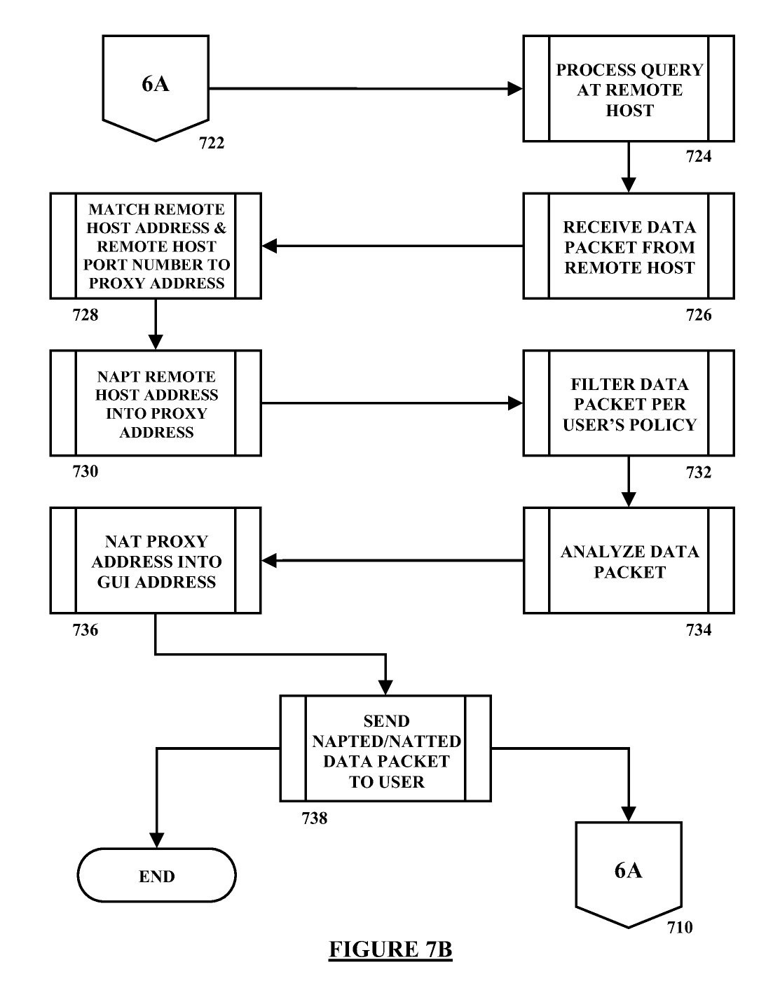

FIG. 7A is a flow chart illustrating the process by which data packets are forwarded from GUIs 112 within a subnet 102 to a remote host 106 via the could service 110 using the firewalled VPN configuration. At step 700 of that process, a user logs on to a GUI 112 within a subnet 102. At step 702, the M/A manager 322 receives user information that identifies that user, a GUI address that identifies that GUI 112, connection information that identifies the VPN connection via which that information was received, and policy information that identifies any policies chosen for that user. That information is received from an authentication agent running on the subnet server 114 within that subnet 102, as discussed above.

After the M/A manager 322 receives the user information, GUI address, connection information, and policy information for a user logged on to a GUI 112 within one of the subnets 102 using the firewalled VPN configuration, the M/A manager 322 checks to determine whether that information is already associated with a proxy address at step 704. If that information is not already associated with a proxy address, at step 706 the M/A manager 322 will obtain a proxy address from a pool of available private network addresses and assign it to the user associated with that information. If the user information, GUI address, connection information, and policy information for a user is already associated with a proxy address and filter mark, the process of FIG. 7A will continue through to steps 708-712 without assigning a proxy address to that user.

The M/A manager 322 assigns different proxy addresses to different users based on each user's unique combination of connection information and GUI address. That combination of information is unique because no two users utilizing the same connection (i.e., no two users with the same connection information) can be associated with the same GUI address (i.e., different users within a subnet 102 will not be allowed to log on to the same GUI 112). And because a customer may maintain multiple connections with the cloud service 110 from multiple subnets 102 and/or customer sites, the authentication agents on the subnet servers 114 in those subnets 102 will provide the datapods 122 with that information so the M/A manager 322 can uniquely identify a user any time that user logs on to a GUI 112 that is in electronic data communication with the cloud service 110 via one of those multiple VPN connections. In other words, the M/A manager 322 can account for customers that utilize multiple connections when communicating with the cloud service 110 by logging those different connections and identifying any users communicating via those connections as being associated with a specific customer based on their respective GUI addresses, which are unique at least with respect to the subnet 102 in electronic data communication with the cloud service via a particular connection.

In addition, because the same user may log on to different GUIs 112 via different connections at different times and, therefore, have different GUI addresses and connection information at different times, step 704 is repeated each time a user logs on to a GUI 112. If the user previously logged on to the same GUI 112 via the same connection, the process of FIG. 7A will proceed through to steps 708-712 without the need to perform step 704. Otherwise, step 706 will be performed to assign a proxy address to that user based on his/her different GUI address and connection information. Step 706 will also be performed if a user logs on to a different GUI 112 via the same VPN connection because that will at least result in a change of the GUI address associated with that user.

At step 708, a user initiates a query at the GUI 112 to which he/she is logged on, which results in the transmittal of forward data packets to the cloud service 110 via the connection between the cloud service 110 and the subnet 102 in which that GUI 112 resides. Those forward data packets include headers with the GUI address and connection information for that GUI 112 and that connection, respectively. Thus, when the cloud service 110 receives those forward data packets at step 710, it has all of the information required to uniquely identify the user from which those forward data packets originated (i.e., the user that initiated the query). The firewall 318 utilizes the connection information at step 710 to apply a firewall mark to the data packet for use in routing that data packet within the concentrator 306.

If a user has not already been associated with a proxy address, as determined at step 704, then step 706 will be performed to assign a proxy address to the user identified with that GUI address and connection information. As discussed above, the M/A manager 322 assigns different proxy addresses to different users based on each user's unique combination of connection information and GUI address, which are forwarded to the M/A manager 322 by the NOC 118 after the user logs on to a GUI 112.

Assigning a proxy address to a user involves associating the connection information, the current GUI address, and the policy information for that user with a private network address designated for use within the cloud service 110. The M/A manager 322 manages that information and uses it to populate the corresponding columns 502-510 and rows 512 of the NAT mapping table 500. As discussed above, the proxy addresses are associated with the policy information based on the policy chosen by the customer for the user associated with that proxy address. And that policy information may be forwarded to the M/A manager 322 by the authentication agent on a subnet server 114 in conjunction with, or separately from, the user information, GUI address, and connection information for each user. Those policy preferences may also be provided by the NOC 118.

After a user is assigned a proxy address at step 706 and after a forward data packet is received at step 710, the SNAT 320 matches the GUI address and connection information received in the headers of those forward data packets with the GUI address and connection information in the NAT mapping table 500 at step 712. By matching that information at step 712, the SNAT 320 is able to determine which proxy address to transform the GUI address into (i.e., the proxy address associated with the matching GUI address and connection information). Then, at step 714, the SNAT 320 performs NAT processing on the forward data packet to transform the GUI address into that proxy address.

At step 716, the data analyzer 308 filters the data packet in accordance with the policy defined by the proxy address assigned to that forward data packet at step 710. Then, at step 718, the data analyzer 308 performs in-line analysis of the forward data packet in accordance with that policy. Performing that in-line analysis is the primary function of the cloud service 110. In other words, that in-line analysis constitutes the service(s) provided by the cloud service 110. The remaining process are provided primarily to support and/or enhance the service(s) provided by the cloud service 110. For example, the NAT process performed at step 714 is provided to allow those services to be provided utilizing a multi-tenant architecture by eliminating the potential for overlapping IP addresses, which would result in ambiguity in trying to determine which services to provide.

At step 720, the SNAT 320 performs NAPT processing on the forward data packet in which the proxy address is translated into the cloud address and the source port number (i.e., the port number corresponding to the port of the GUI 112 from which the forward data packet was received) is translated into a cloud port number. The cloud port number may be same for a specific proxy address each time the NAPT process is performed on a forward data packet with that proxy address, or a different cloud port number can be assigned each time the NAPT process is performed.

The M/A manager 322 populates column 608 of the NAPT mapping table 600 with the cloud port number associated with each proxy address and populates column 606 with the corresponding proxy addresses. The M/A manager 322 also populates column 610 of the NAPT mapping table 600 with the filter mark associated with each proxy address at step 714. And the M/A manager 322 populates columns 602 and 604 of the NAPT mapping table 600 with the remote host address and remote host port number, respectively, which are received in the original headers of the forward data packets at step 710.

At step 722, the forward data packet is transmitted from the cloud service 110 to the remote host identified with the remote host address and remote host port number received in the original headers of the forward data packet at step 710. At that point, however, the original header of that forward data packet will have the GUI address transformed from the GUI address to the cloud address and the source port number transformed to the cloud port number. The proxy address will already have been transformed into the cloud address, and the filter mark will have been removed. In other words, neither the proxy address nor the filter mark will be with the forward data packet after it leaves the cloud service 110. Accordingly, the processes performed on the forward data packet by the cloud service 110, including the analysis performed by the data analyzer 308, will be transparent to the remote host 106 that ultimately receives that forward data packet.

### G. Return Multi-Tenant Traffic

FIG. 7B is a flow chart illustrating the process by which data packets are returned to GUIs 112 within a subnet 102 from a remote host 106 via the could service 110 in response to the data packets forwarded via the process of FIG. 7A. After a forward data packet is received at a remote host 106 via the process of FIG. 7A, that remote host 106 processes the query set forth in that forward data packet, or series of forward data packets, at step 724. In response to that query, the remote host 106 will transmit a return data packet, or series of return data packets, back to the cloud service 110 using the cloud address and cloud port number received in the forward data packet, or series of forward data packets, that set forth that query.

Unlike the forward data packet, or series of forward data packets, that set forth that query, wherein the cloud address and cloud port number represent the source of that forward data packet, the cloud address and cloud port number represent the destination of the return data packet. That return data packet is received at the cloud service at step 726 with the cloud address and cloud port number associated with the user that originated the query. The cloud address and cloud port number are associated with that user by virtue of their association with the proxy address that uniquely identifies that user. The firewall 318 applies a filter mark to the data packet as it is received at step 726 for use in routing that data packet within the concentrator 306. And a specific user is identified as the destination of the return data packet at step 728 by matching that cloud address and cloud port number to the proxy address associated with the same cloud address and cloud port number in the NAPT mapping table 600.

At step 730, the SNAT 320 performs a NAPT process on the return data packet in which the cloud address is transformed back into the proxy address to which that cloud address and the associated cloud port number were matched at step 728. Accordingly, the SNAT 320 utilizes the relationships already defined in the NAPT mapping table 600 translate the cloud address of the return packet back into to the appropriate proxy address. Then, using the proxy address associated with that user at step 706, the data analyzer 308 filters the return data packet in accordance with the policy defined by the policy information associated with that proxy address. And the data analyzer 308 performs in-line analysis of the return data packet in accordance with that policy at step 734.

At step 736, the SNAT 320 performs NAT processing on the return data packet to transform the proxy address back into the GUI address for the user associated with that proxy address in accordance with the relationship already defined in the NAT mapping table 500. Then, at step 738, the datapod 122 transmits the return data packet back to the specific user who originated the forward data packet, or series of forward data packets, to which the return data packet was sent as a response. The specific user is identified by the unique combination of connection information and GUI address associated with the transformed proxy address in accordance with the relationship already defined in the NAT mapping table 500. As discussed above, the connection information and GUI address define the connection and GUI 112, respectively, via which that user can receive return data packets, which is also the connection and GUI 112 via which that user originated the forward data packet, or series of forward data packets, to which the return data packet was sent as a response. Accordingly, transmitting the return data packet back to that user completes the return process illustrated in FIG. 7B.

As should be understood from the discussion above, the forward process of FIG. 7A and the return process of FIG. 7B form a loop that can be repeated as many times as required to send the forward data packets that form a query and the return data packets that form a response to that query. Moreover, the process of FIG. 7A can be repeated a plurality of times before the process of FIG. 7B begins, and the process of FIG. 7B can be repeated plurality of times after the process of FIG. 7A ends. There need not be a one-to-one relationship between the process of FIG. 7A and the process of FIG. 7B. Their respective numbers of occurrence are primarily defined by the amount of data (i.e., the number of data packets) that needs to be transferred to effectuate a query or the response to that query.

### H. Overview

As demonstrated by the discussion above, the apparatus, system, and method of the present invention effectively and efficiently segregate traffic through a cloud service, allowing that cloud service to provide its services to a large number of customers using a multi-tenant software architecture. More particularly, the apparatus, system, and method of the present invention segregate traffic through a cloud service based on specific users and/or groups of users, even where users may be otherwise indistinguishable based on their private network IP addresses and log-in information. Because that apparatus, system, and method allow policies to be applied on a granular basis to specific users and/or groups of users, the present invention is particularly suited for use with web security cloud services.

When connected to a subnet 102 using a firewalled VPN configuration, a proxy forwarding configuration, or a mobile VPN configuration, the present invention allows the cloud service 100 to identify the specific users that originate and receive data packets such that the cloud service 110 is able to apply different policies to different users on a granular, user-by-user basis. And when connected to a subnet 102 using an explicit proxy configuration, the present invention allows the cloud service 100 to identify specific users that originate and receive data packets users as belonging a group of users such that the cloud service 110 is able to apply different policies to different users on subnet-by-subnet basis without requiring those users to input a user name and password to obtain those services each time the user initiates a data query. That ability to differentiate between specific users and groups of users in that manner further allows the cloud service 110 to implement its services using a multi-tenant software architecture by allowing the cloud service 110 to efficiently and effectively segregate traffic between different users and/or groups of users.

The use of such cloud services can reduce an organization's energy costs by allowing them to centralize software and data storage management while eliminating the need for the hardware, software, and IT personnel that would otherwise be required to build, support, and maintain those services in-house. Moreover, the unique configuration of the present invention improves the efficiency of the actual cloud service being provided by allowing it to be implemented using a multi-tenant software architecture, thereby eliminating the costs associated with operating and maintaining different instances of software for different customers. Thus, in addition to the advantages discussed above, the present invention contributes to the restoration and/or maintenance of basic life-sustaining natural elements, such as fossil fuels. In doing so, the present invention also has the potential to materially contribute to the energy conservation and greenhouse emission reduction, particularly when implemented on a large scale.

The foregoing description and drawings should be considered as illustrative only of the principles of the invention. The invention may be configured in a variety of shapes and sizes and is not intended to be limited by the preferred embodiments. Numerous applications of the invention will readily occur to those skilled in the art. For example, the cloud service 110 is not limited to servicing data queries from GUIs 112 and mobile devices 104. It can also service data queries from other devices, such as headless servers. Therefore, it is not desired to limit the invention to the specific examples disclosed or the exact construction and operation shown and described. Rather, all suitable modifications and equivalents may be resorted to, falling within the scope of the invention.

What is claimed is:

1. An apparatus configured to perform multi-tenant NATting for segregating customer traffic through a cloud service, the apparatus including:
a memory;
one or more network interfaces;
one or more processors; and
computer program code stored on a non-transitory storage medium, the computer program code including computer-readable instructions operative, when executed, to cause the one or more processors to
perform network address translation (NAT) on first and second data packets as they are transmitted between the cloud service and a plurality of subnets, the NAT being performed to translate each of a plurality of first private network IP addresses from the plurality of subnets into a second private network IP address for use within the cloud service after said first data packets are received from the plurality of subnets and to translate the second private network IP address back into a corresponding one of the plurality of first private network IP addresses before said second data packets are sent to the plurality of subnets; and
perform network address and port translation (NAPT) on the first and second data packets as they are transmitted between the cloud service and one or more remote hosts, the NAPT being performed to translate a first public network IP address for the one more remote hosts into the second private network IP address after said second data packets are received from the one or more remote hosts and to translate the second private network IP address into a second public network IP address for the cloud service before sending said first data packets to the one or more remote hosts.

2. The apparatus of claim 1, further comprising a data analysis engine configured to filter the first and second data packets in accordance with one or more policies as the first and second data packets pass between the plurality of subnets and the one or more remote hosts via the cloud service, each of the one or more policies being selected based on the second private network IP addresses of the first and second data packets.

3. The apparatus of claim 2, wherein the data analysis engine is further configured to perform in-line analysis of the first and second data packets in accordance with the one or more policies as the first and second data packets pass between the plurality of subnets and the one or more remote hosts via the cloud service, the in-line analysis including at least one of anti-virus (AV) scanning, dynamic real-time rating (DRTR), and content filtering service (CFS).

4. The apparatus of claim 2, further comprising a firewall configured to apply a filter mark to the first data packets when they are received from the plurality of subnets, to remove the filter mark from the first data packets before they are transmitted to the one or more remote hosts, to apply the filter mark to the second data packets when they are received from the one or more remote hosts, and to remove the filter mark from the second data packets before they are transmitted to the plurality of subnets.

5. The apparatus of claim 4, wherein
the data analysis agent performs in-line analysis of the first and second data packets in accordance with one or more policies; and
each of the one or more policies is selected based on the second private network IP addresses of the first and second data packets.

6. The apparatus of claim 1, wherein
the second private network IP address is specific to one user; and
the one user is identified based on the subnet from which the first data packets were received and a corresponding one of the plurality of first private network IP addresses.

7. The apparatus of claim 6, wherein
each of the plurality of first private network IP addresses is associated with a connection via which a computer within one of the plurality of subnets is connected to the apparatus, the computer being the source of the first data packets; and
each second private network IP address is assigned to the first data packets based on the connection.

8. The apparatus of claim 7, wherein
each of the plurality of first private network IP addresses is further associated with a user ID used to log on to the computer; and
each second private network IP address is further assigned to the first data packets based on a combination of the connection and the user ID.

9. A method of performing multi-tenant NATting for segregating customer traffic through a cloud service, the method comprising the steps of:
performing network address translation (NAT) on first data packets to translate a plurality of different first private network IP addresses into a plurality of different second private network IP addresses, each of the second private network IP addresses being assigned based on a subnet and a first private network IP address from which the corresponding first data packets were received;
performing network address and port translation (NAPT) on the first data packets to translate each of the plurality of different second private network IP addresses into a first public network IP address for the cloud service; and
sending the NATted and NAPTed first data packets to one or more remote hosts.

10. The method of claim 9, further comprising the step of receiving the first data packets from one of the plurality of subnets, the first data packets corresponding to one or more queries performed at a computer within that subnet and having a first private network IP address that corresponds to that computer.

11. The method of claim 9, further comprising the step of applying a filter mark to the first data packets as the first data packets are received.

12. The method of claim 11, further comprising the steps of:
filtering the first data packets within the cloud service using the filter mark; and
removing the filter mark from the first data packets before they leave the cloud service.

13. The method of claim 9, further comprising the step of performing in-line analysis of the first data packets, the in-line analysis including at least one of anti-virus (AV) scanning, dynamic real-time rating (DRTR), and content filtering service (CFS).

14. The method of claim 13, further comprising the step of selecting one or more policies based on the second private network IP address of the first data packets, wherein the step of performing in-line analysis includes performing in-line analysis of the first data packets in accordance with the one or more policies.

15. The method of claim 9, further comprising the steps of:
receiving second data packets from the one or more remote hosts, the second data packets being sent in response to the one or more queries and having one or more second public network IP addresses for the corresponding one or more remote hosts; and
performing NAPT on the second data packets to translate each of the one or more second public network IP addresses into the second private network IP address that corresponds to the subnet and first private network IP address of the computer at which the corresponding query was performed.

16. The method of claim 15, further comprising the step of applying a filter mark to the second data packets as the second data packets are received.

17. The method of claim 16, further comprising the steps of:
filtering the second data packets within the cloud service using the filter mark; and
removing the filter mark from the second data packets before they leave the cloud service.

18. The method of claim 17, further comprising the step of performing in-line analysis of the second data packets, the in-line analysis including at least one of AV scanning, DRTR, and CFS.

19. The method of claim 17, further comprising the steps of:
performing NAT on the second data packets to translate each different second private network addresses back into the corresponding different first private network IP address; and
sending each of the NAPTed and NATted second data packets to the subnet in which the corresponding query was performed.

20. The method of claim 15, further comprising the steps of:
receiving one or more user IDs from one or more connection logging agents at one or more of the plurality of subnets, wherein
each first private network IP address is associated with a computer at which one of the one or more users is logged on within one of the plurality of subnets,
each first private network IP address is further associated with the user ID of the user logged on to the computer with that first private network IP address, and
the step of performing NAT on the first data packets includes assigning a second private network IP address to the first data packets based on the user ID of the user logged on to the computer from which the corresponding first data packets were received.
